(19) United States
(12) Patent Application Publication
(10) Pub. No.: US 2009/0031267 A1
(43) Pub. Date: Jan. 29, 2009

(54) Layout correcting method for semiconductor integrated circuit and layout correcting device for semiconductor integrated circuit

(75) Inventor: Takeshi Ueki, Kawasaki (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/219,021

(22) Filed: Jul. 15, 2008

(30) Foreign Application Priority Data
Jul. 25, 2007 (JP) 2007-192871

(51) Int. Cl. G06F 17/50

(52) U.S. Cl. 716/5; 716/12

(57) ABSTRACT

A layout correction method, which minimize influence of changing a dummy metal on timings when signal wirings are corrected after completion of arrangement design of wirings including dummy metals, includes the steps of correcting, on a layout of a semiconductor integrated circuit in which at least signal wirings and a dummy metal are arranged, the signal wirings by ignoring the dummy metal, checking a wiring error between the dummy metal and the signal wirings corrected by ignoring the dummy metal, removing the dummy metal that causes the wiring error if the wiring error is found, and embedding another dummy metal after the dummy metal is removed.

### BACKGROUND OF THE INVENTION

1. Field of the Invention

The present invention relates to a method of correcting a layout of a semiconductor integrated circuit and a layout correcting device for a semiconductor integrated circuit. In particular, the present invention relates to a method of correcting a layout of a semiconductor integrated circuit and a layout correcting device for a semiconductor integrated circuit, involving an arrangement of dummy metals.

2. Description of the Related Art

In a manufacturing process of semiconductor integrated circuits, a deviation in flatness of chemical mechanical polishing (CMP) may occur because of a deviation in density of wiring. There is a known technology to resolve such a deviation in flatness, in which dummy metals (dummy wirings) are disposed in a region where signal wirings or power supply wirings are not dense so that unevenness in density of wiring can be corrected. A technology for performing a process of arranging such dummy metals is disclosed, for example, in JP 2002-342399 A.

Specifically, JP 2002-342399 A discloses a method and program for designing dummy patterns (dummy metals) accompanying a polishing process and a recording medium recording the program. This is a method of designing dummy metals that are different from wiring patterns of the aforementioned wiring layer formed on a wiring layer of a semiconductor device. This method of designing dummy metals includes the following steps: (a) a step of performing a polishing simulation based on pattern density of the wiring layer to calculate a film thickness of a layer to be polished indicating a height from a predetermined reference surface to a polished surface in each of calculation unit regions defined on a chip; (b) a step of determining whether or not a surface-step difference of the polished surface is within a tolerance based on the film thickness of a layer to be polished in each of the calculation unit regions obtained by the calculation described above; (c) a step of obtaining a permissible pattern density indicating an upper limit value of the pattern density in the calculation unit region when the dummy metal is disposed so that an inter wiring capacitance between a wiring pattern and the dummy metal in each of the calculation unit regions becomes a predetermined value or smaller, and an appropriate pattern density indicating a pattern density in the calculation unit region when the dummy pattern is disposed so that the surface-step difference of the polished surface becomes within the tolerance if it was determined that the surface-step difference of the polished surface is not within the tolerance; and (d) a step of deciding a correcting pattern density-in the calculation unit region based on the permissible pattern density and the appropriate pattern density. The pattern density of the wiring layer in the step (a) is replaced with the correcting pattern density, and the steps (a) to (d) are repeated until it is determined that the surface-step difference of the polished surface is within the tolerance, so the pattern density in each of the calculation unit regions is decided.

After completion of designing arrangement of wirings including dummy metals, a malfunction may be found from a result of manufacturing a prototype. In order to correct the malfunction or to make a modification to the design, it may be necessary to correct signal wirings in the layout pattern. In this case, the method of correcting the layout of signal wirings is considered to be as follows.

The present inventor has now discovered the following problems. FIG. 1 is a flowchart illustrating a procedure of correcting the layout of signal wirings to which the method of JP 2002-342399 A is applied. FIGS. 2 to 5 are schematic diagrams each illustrating an example (a part) of the layout pattern of signal wirings in each step shown in FIG. 1. Note that FIGS. 1 to 5 are diagrams for the inventor of the present invention to describe a problem derived from the technology disclosed in JP 2002-342399 A. First, as shown in FIG. 2, signal wirings 111a to 111g and dummy metals 113a to 113h are arranged on an imaginary grid of the layout pattern after the design of wiring arrangement is completed. Here, if it becomes necessary to correct the signal wirings 111a and 111b, correction of the layout of signal wirings is performed as follows.

First, all the dummy metals 113 are removed (step S101 of FIG. 1). In the case of FIG. 2, all the dummy metals 113a to 113h are removed. As a result, the layout pattern becomes as shown in FIG. 3. The signal wirings 111a to 111g are remaining on the grid.

Next, a process of correcting the signal wirings is performed (step S102 of FIG. 1). In the case of FIG. 3, the signal wirings 111a and 111b are corrected to move to desired positions. As a result, the layout pattern becomes as shown in FIG. 4. On the grid, the positions of the signal wirings 111a and 111b are corrected, and the signal wirings 111a and 111b are relocated as signal wirings 112a and 112b. Positions of other signal wirings 111c to 111g are not corrected.

Next, a process of arranging the dummy metals is performed (step S103 of FIG. 1). In the case of FIG. 4, dummy metals 114a to 114h are arranged in regions where the signal wirings 112a, 112b, and 111c to 111g are not arranged, based on a predetermined dummy metal arrangement rule. As a result, the layout pattern becomes as shown in FIG. 5. The signal wirings 112a, 112b, 111c to 111g, and the dummy metals 114a to 114h are arranged on the grid.

After that, a verification process is performed (step S104 of FIG. 1). If an error is found (Yes in step S105 of FIG. 1), correction is performed (step S106 of FIG. 1), and the steps described above are repeated. If no error is found (No in step S105 of FIG. 1), the steps described above are finished.

Comparing FIG. 2 with FIG. 5, it is understood that the dummy metals 113a, 113b, 113f, 113g, and 113m are substantially the same as the dummy metals 114a, 114b, 114f, 114g, and 114h, respectively. However, the dummy metal 114c is disposed at the position corresponding to the dummy metal 113c, having lengths substantially different from each other. Similarly, the dummy metals 114d and 114e are arranged at the positions corresponding to the dummy metals 113j and 113k, respectively, having lengths substantially different from each other. In addition, any dummy metals are not arranged at the positions corresponding to the dummy metals 113d, 113e, 113h, 113i, and 113l.

It has become clear from the research by the inventor of the present invention that when all the dummy metals are corrected, there is a problem as described below. In this method, all the dummy metals (113a to 113h) are removed first in order to correct the signal wirings (111a and 111b). Then, after the correction of the signal wirings (signal wirings 112a and 112b), the dummy metals are reembedded (dummy metals 114a to 114h). Therefore, the dummy metals that are not to be corrected actually are also corrected.

For example, comparing FIG. 2 with FIG. 5, it is understood that the dummy metals 113d and 113l should be corrected (removed in this case) so that they will not overlap with the signal wirings 112a and 112b after the correction, but it is not necessary to correct other dummy metals 113. However, the dummy metals 113c, 113j, and 113k are actually corrected in sizes as the dummy metals 114c, 114d, and 114e, and the dummy metals 113d, 113e, 113h, 113i, and 113l are removed after the correction. Since all the dummy metals are removed and a process of relocating the dummy metals is performed again, locations where the layout pattern is changed will increase.

As a result, the inter wiring capacitance will be changed not only between the dummy metal and the signal wiring that is corrected but also between the dummy metal and the signal wiring that is not corrected. When the inter wiring capacitance is changed, timing operations of the semiconductor device may be adversely affected. In other words, not only the timing operation at the location of the corrected signal wiring and its vicinity but also the timing operation at other locations of signal wirings may be adversely affected.

Therefore, it is desired to provide a technology for correcting a layout of a semiconductor integrated circuit, which enables to minimize influence of changing dummy metals on timing operations even if signal wirings are corrected after completing designing arrangement of wirings including dummy metals.

### SUMMARY

The method according to the present invention includes: correcting signal wirings by ignoring a dummy metal; checking a wiring error between the dummy metal and the signal wirings corrected by ignoring the dummy metal; and removing the dummy metal that causes the wiring error and disposing a dummy metal different from the dummy metal that causes the wiring error if the wiring error is found.

According to the present invention, when a signal wiring is corrected after a process of embedding dummy metals (dummy wirings) is completed, all the dummy metals are not removed before the wiring process. Instead, the dummy metals are ignored when the wiring process is performed, and only the dummy metal that becomes a wiring error after completion of the wiring process is removed. Then, at the location where the dummy metal is removed and its vicinity as well as at the location where the signal wiring is corrected and its vicinity, the dummy metals are relocated (reembedded) so that a rule of the dummy metals (dummy metal arrangement-rule) can be satisfied.

Therefore, comparing with the conventional method in which all the dummy metals are removed and then the dummy metals are reembedded, the region where the dummy metal is relocated can be restricted to a very small region according to the method of the present invention. As a result, a quantity of the relocated dummy metal can be reduced substantially, so the influence of the changing the dummy metal on the timing operation can be minimized.

According to the present invention, a change of the dummy metal accompanying a change of the signal wiring can be reduced so that the influence of the changing the dummy metal on the timing operation can be reduced.

### BRIEF DESCRIPTION OF THE DRAWINGS

The above and other objects, advantages and features of the present invention will be more apparent from the following description of certain preferred modes taken in conjunction with the accompanying drawings, in which:

FIG. 1 is a flowchart of a method of correcting a layout of signal wirings so as to illustrate a problem;

FIG. 2 is a schematic diagram illustrating an example of a layout pattern of signal wirings in each step shown in FIG. 1;

FIG. 3 is a schematic diagram illustrating another example of the layout pattern of the signal wirings in each step shown in FIG. 1;

FIG. 4 is a schematic diagram illustrating another example of the layout pattern of the signal wirings in each step shown in FIG. 1;

FIG. 5 is a schematic diagram illustrating another example of the layout pattern of the signal wirings in each step shown in FIG. 1;

FIG. 6 is a block diagram illustrating a structure of an embodiment of a layout correcting device for a semiconductor integrated circuit according to the present invention;

FIG. 7 is a flowchart illustrating an operation of the embodiment of the layout correcting device for a semiconductor integrated circuit according to the present invention;

FIG. 8 is a schematic diagram illustrating an example of a layout pattern of signal wirings in each step shown in FIG. 7;

FIG. 9 is a schematic diagram illustrating another example of the layout pattern of the signal wirings in each step shown in FIG. 7;

FIG. 10 is a schematic diagram illustrating another example of the layout pattern of the signal wirings in each step shown in FIG. 7; and

FIG. 11 is a schematic diagram illustrating another example of the layout pattern of the signal wirings in each step shown in FIG. 7.

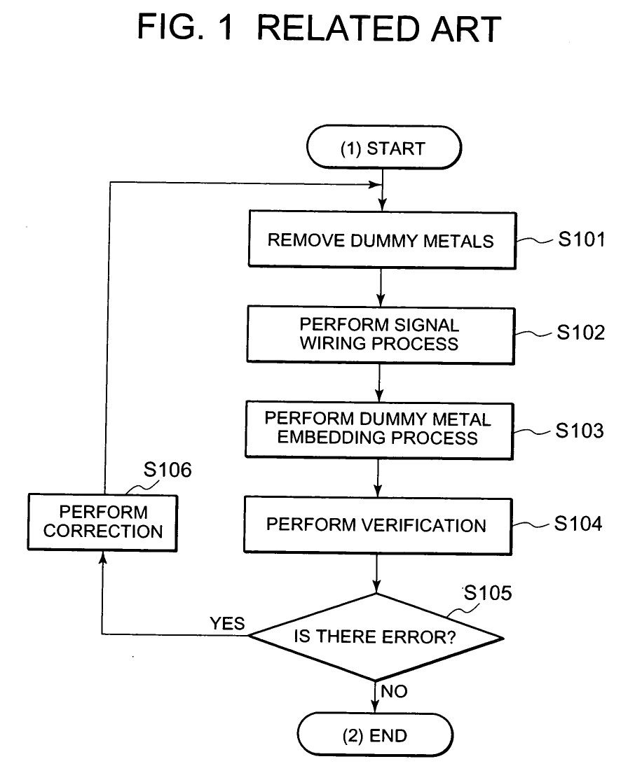

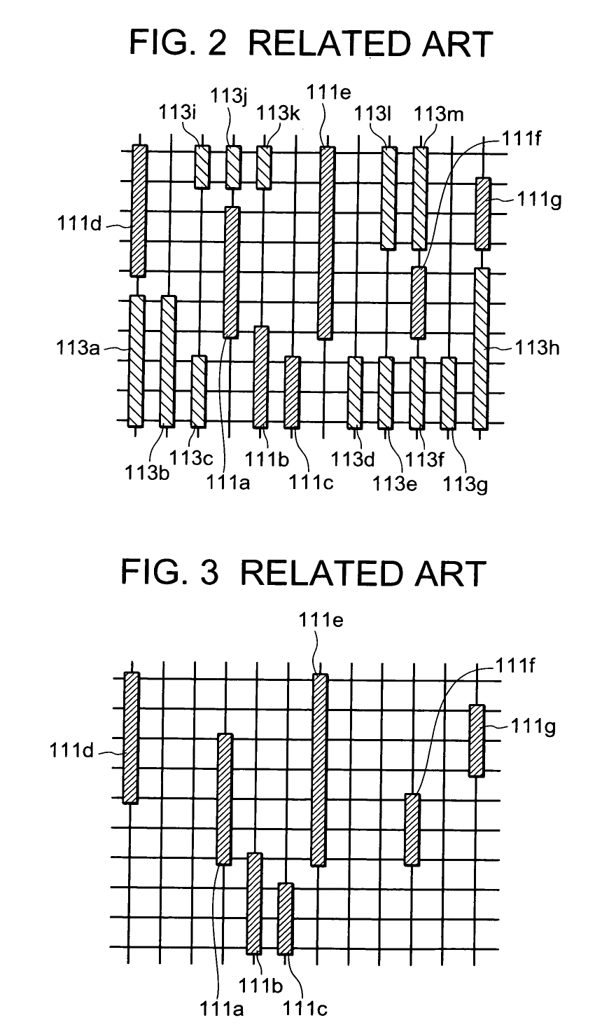

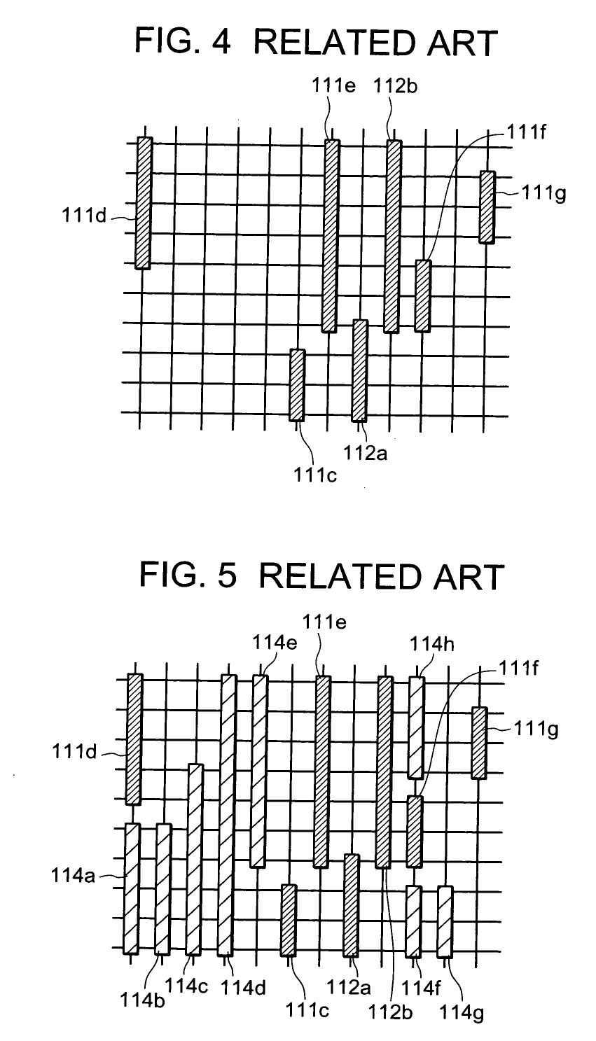

### DETAILED DESCRIPTION OF THE PREFERRED EMBODIMENT

The invention will be now described herein with reference to illustrate embodiments. Those skilled in the art will recognize that many alternative embodiments can be accomplished using the teachings of the present invention and that the invention is not limited to the embodiments illustrated for explanatory purposes. A layout correcting method and a layout correcting device according to a first embodiment of the present invention will be described with reference to the attached drawings.

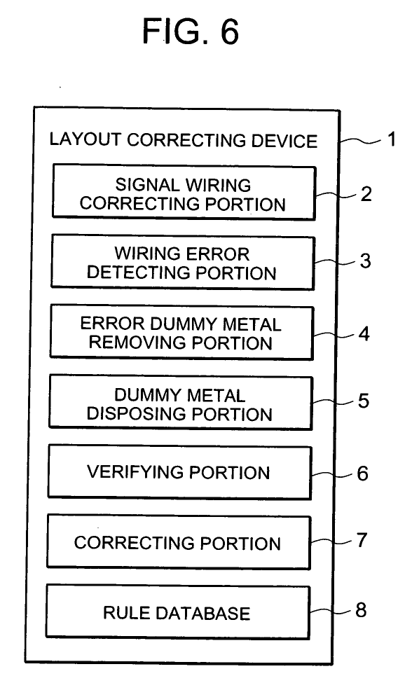

First, a structure of an embodiment of the layout correcting device for a semiconductor integrated circuit according to the present invention will be described. FIG. 6 is a block diagram illustrating the structure of the embodiment of the layout correcting device for a semiconductor integrated circuit according to the present invention. A layout correcting device 1 for a semiconductor integrated circuit is used for correcting a layout of a semiconductor integrated circuit in which at least signal wirings and dummy metals (dummy wirings) are arranged and wired. The layout correcting device 1 for a semiconductor integrated circuit is an information processing device such as a personal computer in which a layout correcting program for a semiconductor integrated circuit (corresponding to the method of correcting a layout of a semiconductor integrated circuit) according to the present invention is installed, which works as the layout correcting device 1 for a semiconductor integrated circuit according to the present invention. The layout correcting program for a semiconductor integrated circuit includes a signal wiring correcting portion 2, a wiring error detecting portion 3, an error dummy metal removing portion 4, a dummy metal disposing portion 5, a verifying portion 6, a correcting portion 7, and a rule database 8.

The rule database 8 stores at least a wiring design rule that is referred to when design rule check (DRC) is performed and a dummy metal arrangement rule that is referred to when the dummy metals (dummy wirings) are arranged. The dummy metal arrangement rule includes settings such as a shape of the dummy metal, a space between dummy metals, a space between a dummy metal and wiring, and a range of metal density. The metal density indicates a ratio of area between metal regions (dummy metals and wirings) and other regions. A value within a predetermined range is set so that the ratio does not become uneven on the surface of the semiconductor integrated circuit device.

The signal wiring correcting portion 2 performs correction of desired signal wirings among a plurality of signal wirings for a layout pattern of a semiconductor integrated circuit in which at least a plurality of signal wirings and a plurality of dummy metals are arranged and wired, by ignoring the plurality of dummy metals.

The wiring error detecting portion 3 performs the DRC about a relationship between the signal wirings that are corrected by ignoring the plurality of dummy metals and the plurality of dummy metals, so as to check whether or not a DRC error is found. The DRC error is exemplified by a wiring error.

If a DRC error is found by the check described above, the error dummy metal removing portion 4 removes the dummy metal in which the DRC error is found.

After the dummy metal is removed, the dummy metal disposing portion 5 refers to the rule database 8 and performs a process of arranging dummy metals at the location of the removed dummy metal and its vicinity as well as at the location of the corrected signal wiring and its vicinity. Further, the dummy metal disposing portion 5 disposes the dummy metals based on the dummy metal arrangement rule.

The verifying portion 6 performs resistance and capacitance extraction (RC extraction), timing verification, and the like about data of the layout in which dummy metals are arranged.

If a timing error is detected as a result of the verification, the correcting portion 7 performs optimization of timing (correction of the timing error) so that the timing error disappears.

The layout correcting program for a semiconductor integrated circuit according to the present invention described above may be incorporated in an automatic wiring arrangement apparatus for a semiconductor device or an automatic designing apparatus for a semiconductor device.

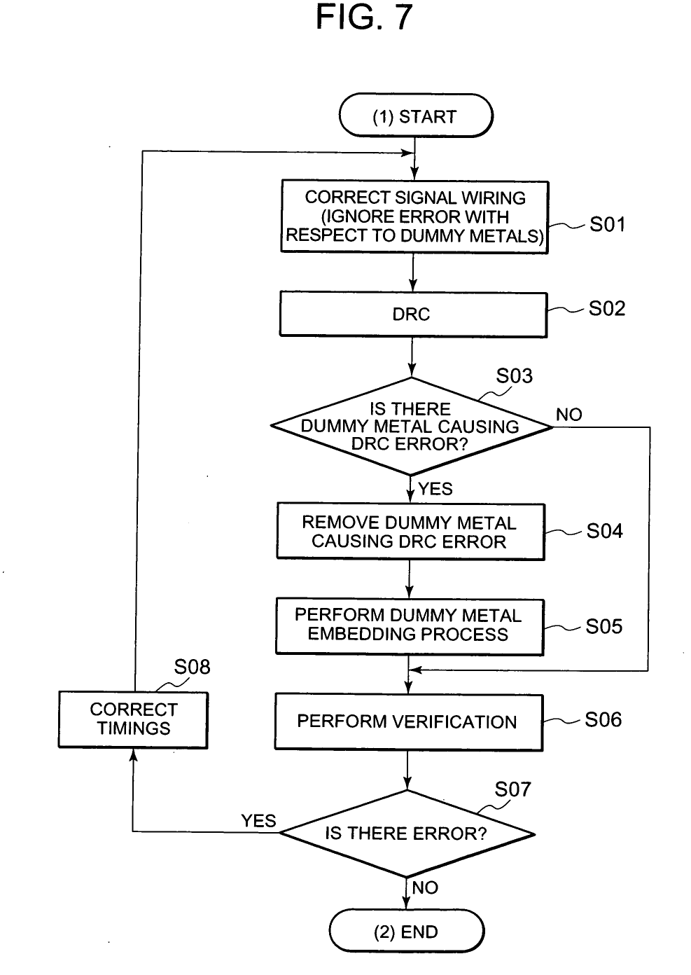

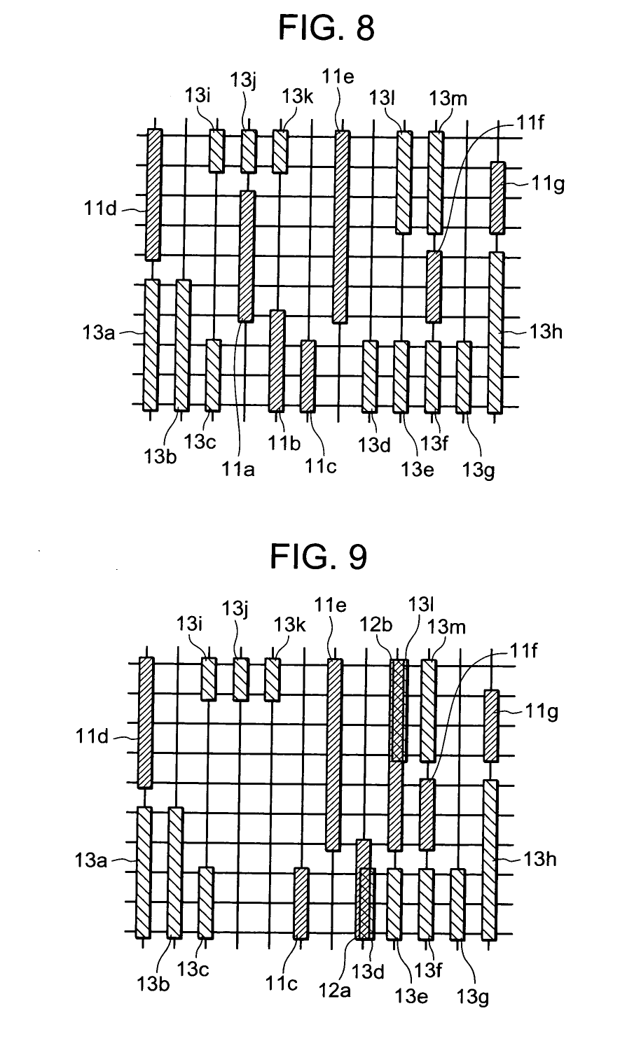

Next, an operation of an embodiment of the layout correcting device for a semiconductor integrated circuit (corresponding to the method of correcting a layout of a semiconductor integrated circuit) according to the present invention will be described. FIG. 7 is a flowchart illustrating the operation of the embodiment of the layout correcting device for a semiconductor integrated circuit according to the present invention. FIGS. 8 to 11 are schematic diagrams each illustrating an example (a part) of a layout pattern of signal wirings in each step shown in FIG. 7.

First, as shown in FIG. 8, signal wirings 11a to 11g and dummy metals 13a to 13h are arranged on an imaginary grid of the layout pattern after the design of wiring arrangement is completed. Here, if it becomes necessary to correct the signal wirings 11a and 11b, correction of the layout of signal wirings is performed as follows.

### (1) Step S01 (FIG. 7)

The signal wiring correcting portion 2 of the layout correcting device 1 for a semiconductor integrated circuit reads layout pattern data indicating a layout pattern (FIG. 8) of a semiconductor integrated circuit in which at least a plurality of signal wirings 11a to 11g and a plurality of dummy metals 13a to 13h are arranged and wired. Then, as to the layout pattern (FIG. 8), desired correction is performed on the signal wirings 11a and 11b to be corrected among the plurality of signal wirings, by ignoring the plurality of dummy metals 13a to 13h. As a result, the layout pattern shown in FIG. 8 becomes that shown in FIG. 9. Specifically, as shown in FIG. 9, the signal wirings 11a and 11b are corrected to be arranged as the signal wirings 12a and 12b without changing the arrangement of the signal wirings 11c to 11g and the dummy metals 13a to 13h on the grid.

Note that the layout pattern data about the layout pattern (FIG. 8) of the semiconductor integrated circuit to be corrected by the correction method may be input externally or stored in advance in a storage device (not shown) of the layout correcting device 1 for a semiconductor integrated circuit.

### (2) Step S02 (FIG. 7)

Next, the wiring error detecting portion 3 of the layout correcting device 1 for a semiconductor integrated circuit performs the DRC about a relationship between the signal wirings 12a and 12b that are corrected by ignoring the plurality of dummy metals 13a to 13h and the plurality of dummy metals 13a to 13h, so as to check whether or not a DRC error is found. In other words, the wiring error detecting portion 3 checks whether or not a DRC error (wiring error) is found about the layout pattern shown in FIG. 9.

### (3) Step S03 (FIG. 7)

Here, if the wiring error detecting portion 3 of the layout correcting device 1 for a semiconductor integrated circuit does not find a wiring error (No in step S03), the process goes to the verifying portion 6 (step S06).

On the contrary, if the wiring error detecting portion 3 finds a wiring error (Yes in step S03), the process goes to the error dummy metal removing portion 4 (step S04).

In the case of the layout pattern shown in FIG. 9, the signal wirings 12a and 12b partly overlap with the dummy metals 13l and 13d, respectively, resulting in a wiring error. Therefore, the process goes to the error dummy metal removing portion 4 (step S04).

### (4) Step S04 (FIG. 7)

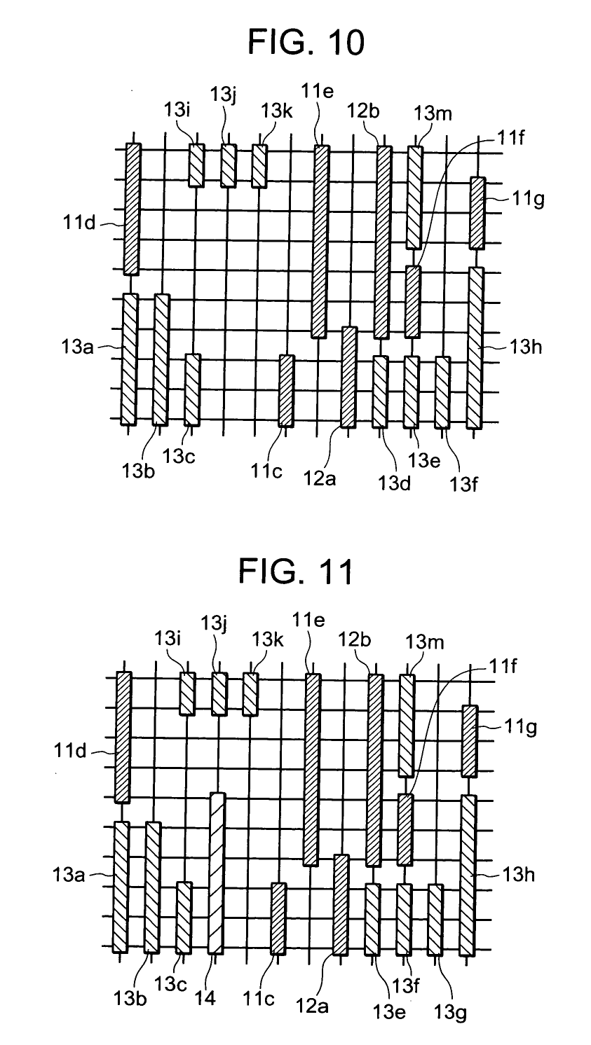

After that, the error dummy metal removing portion 4 of the layout correcting device 1 for a semiconductor integrated circuit removes the dummy metals 13l and 13d that caused the wiring error based on the wiring error found in the check described above (indicating that the signal wirings 12a and 12b partly overlap the dummy metals 13l and 13d, respectively). As a result, the layout pattern shown in FIG. 9 becomes that shown in FIG. 10.

### (5) Step S05 (FIG. 7)

Next, the dummy metal disposing portion 5 of the layout correcting device 1 for a semiconductor integrated circuit refers to the rule database 8 after the above-mentioned dummy metals 13l and 13d are removed, so as to perform a process of arranging dummy metals at the location of the removed dummy metals 13l and 13d and vicinities thereof as well as at the location of the corrected signal wirings 11a, 11b, 12a, and 12b and vicinities thereof. Thus, a dummy metal 14 is relocated based on the dummy metal arrangement rule at the location of the removed dummy metals (13l and 13d) and the corrected signal wirings (11a, 11b, 12a, and 12b) and vicinities thereof.

As a result, the layout pattern shown in FIG. 10 becomes that shown in FIG. 11. In the case of the layout pattern shown in FIG. 11, the dummy metal 14 is disposed so as to satisfy a metal density rule at the location of the removed signal wirings 11a and 11b and vicinities thereof.

### (6) Step S06 (FIG. 7)

Next, the verifying portion 6 of the layout correcting device 1 for a semiconductor integrated circuit performs verification of the RC extraction, the timing verification, and the like about the layout data in which the dummy metal 14 is newly arranged (FIG. 11).

### (7) Step S07 (FIG. 7)

Then, if the verifying portion 6 of the layout correcting device 1 for a semiconductor integrated circuit does not find an error (No in step S07), the process is finished. Then, the layout pattern data after the process is output. On the contrary, if the verifying portion 6 finds an error (Yes in step S07), the process goes to the correcting portion 7 (step S08).

In the case of the layout pattern shown in FIG. 10, the process is finished because no error is found.

### (8) Step S08 (FIG. 7)

The correcting portion 7 of the layout correcting device 1 for a semiconductor integrated circuit performs optimization of timing (correction of the timing error) so that the timing error disappears about the timing error found in the above-mentioned verification.

As described above, the layout correcting device for a semiconductor integrated circuit (corresponding to the method of correcting a layout of a semiconductor integrated circuit) according to the present invention is embodied.

As described above, according to the present invention, if it becomes necessary to draw a signal wiring after arrangement of dummy metals (dummy wirings) is completed, all the dummy metals are not removed before the wiring process. Instead, the dummy metals are ignored when the wiring process is performed, and only the dummy metal that causes a DRC error after completion of the wiring process is removed.

If all the dummy metals are removed before the relocation of the dummy metals, timings are affected substantially.

However, according to the present invention, quantity of dummy metals to be relocated is reduced as much as possible, so the influence of the relocation on timings can be minimized.

The program according to the present invention may be recorded in a computer readable storage medium, and an information processing device may read the program from the storage medium.

It is apparent that the present invention is not limited to the embodiment described above, and the embodiment can be modified or changed as appropriately within the scope of the technical concept of the present invention.

What is claimed is:

1. A layout correcting method for a layout of a semiconductor integrated circuit in which a wiring and a dummy metal are arranged, the method comprising:
correcting the wiring without changing the dummy metal;
checking a wiring error between the dummy metal and the corrected wiring;
removing the dummy metal that causes the wiring error when the wiring error is found; and
placing a dummy metal other than the removed dummy metal.

2. The layout correcting method for the semiconductor integrated circuit according to claim 1, wherein the wiring is a signal wiring.

3. The layout correcting method for the semiconductor integrated circuit according to claim 2, wherein the step of placing a dummy metal other than the removed dummy metal includes placing a dummy metal other than the removed dummy metal in a space generated by removing the dummy metal that causes the wiring error, based on a wiring rule.

4. The layout correcting method for the semiconductor integrated circuit according to claim 3, wherein the wiring is formed on the same wiring layer as the dummy metal.

5. A computer readable medium storing a program executed by a computer for performing a layout correction method for a semiconductor integrated circuit in which a wiring and a dummy metal are arranged, the layout correction method comprising:
correcting the wiring without changing the dummy metal;
checking a wiring error between the dummy metal and the corrected wiring;
removing the dummy metal that causes the wiring error when the wiring error is found; and
placing a dummy metal other than the removed dummy metal.

6. The computer readable medium storing the program according to claim 5, wherein the wiring is a signal wiring.

7. The computer readable medium storing the program according to claim 6, wherein the step of placing a dummy metal includes placing a dummy metal other than the removed dummy metal in a region obtained by the step of removing the dummy metal, based on a wiring rule.

8. A layout correcting device for a semiconductor integrated circuit in which a signal wiring and dummy metal are arranged, the layout correcting device comprising:
a signal wiring correcting portion for correcting the signal wiring without changing the dummy metal;
a wiring error detecting portion for checking a wiring error between the dummy metal and the corrected signal wiring;
an error dummy metal removing portion for removing the dummy metal that causes the wiring error when the wiring error is found; and
a dummy metal placing portion for embedding another dummy metal after the dummy metal is removed.
